(19) United States
(12) Patent Application Publication
(10) Pub. No.: US 2015/0059285 A1
(43) Pub. Date: Mar. 5, 2015

(54) Device for filling and closing capsules

(71) Applicant: Fette Engineering GmbH, Schwarzenbek (DE)

(72) Inventors: Thomas Heinrich, Stelle (DE); Daniel Malick, Ahrensburg (DE); Jan Fabian Scheffler, Hamburg (DE); Rüdiger Heed, Bad Schwartau (DE); Jan-Eric Kruse, Meerbusch (DE)

(73) Assignee: Fette Engineering GmbH, Schwarzenbek (DE)

(21) Appl. No.: 14/471,818

(22) Filed: Aug. 28, 2014

(30) Foreign Application Priority Data
Aug. 30, 2013 (DE) 10 2013 109 471.6

(51) Int. Cl. B65B 65/00; B65B 1/30; A61J 3/07; B65B 7/28

(52) U.S. Cl. CPC B65B 65/003; B65B 7/28; B65B 1/30; A61J 3/072; A61J 3/074
USPC 53/167; 53/564

(57) ABSTRACT

The invention relates to a device for filling and closing capsules made up of a capsule upper part and a capsule lower part, comprising a plurality of processing stations arranged along a preferably circular conveyor belt and a plurality of capsule conveying devices which in each case have a plurality of capsule receivers for receiving one respective capsule, the capsule conveying devices conveying received capsules along the conveyor belt through the processing stations, at least two belt portions arranged in succession being formed along the conveyor belt, a first group of processing stations arranged in succession being provided along a first belt portion, and at least one further group of stations of processing stations arranged in succession being provided along at least one further belt portion, the groups of stations comprising at least one respective supply station, for supplying capsules to be filled into the capsule receivers of the capsule conveying devices, at least one respective opening station for opening the capsules to be filled, by separating the capsule upper parts from the capsule lower parts, at least one respective metering station for filling the capsule lower parts with the material to be filled, at least one respective closing station for closing the filled capsules by placing the capsule upper parts onto the filled capsule lower parts and at least one ejection station for ejecting the filled capsules.

### FIELD OF THE INVENTION

The invention relates to a device for filling and closing capsules made up of a capsule upper part and a capsule lower part, comprising a plurality of processing stations arranged along a preferably circular conveyor belt and a plurality of capsule conveying devices which in each case have a plurality of capsule receivers for receiving one respective capsule, the capsule conveying devices conveying received capsules along the conveyor belt through the processing stations.

### BACKGROUND OF THE INVENTION

Such devices are also denoted as rotary table capsule filling machines. They have different stations along the conveyor belt, in particular a supply station for supplying the pre-closed capsules to be filled, an opening station in which the capsule halves are separated, one or more metering stations in which the material to be filled is filled into the capsule lower parts, a closing station in which the capsule halves are closed and an ejection station in which the finished capsules are ejected. Moreover, a plurality of empty stations are frequently provided, said empty stations being able to be used in different ways, depending on the intended use.

Conventional devices of this type are generally designed to use simultaneously up to five (different or the same) metering stations. In such devices, up to twelve processing stations result, distributed over the conveyor belt. Such a device is disclosed, for example, in DE 10 2004 048 007 A1, the entire contents of which are hereby incorporated by reference.

In the devices under discussion, corresponding capsule conveying devices move toward the processing stations, in particular in a cyclical manner. The capsule conveying devices receive a predetermined number of capsules. The number of capsules to be received determines the maximum output achievable by the device in addition to the cycle time. Devices with an average output have between eight and twelve capsule receivers per capsule conveying device, the capsules being arranged along one row. Machines with a higher output receive twice as many capsules per capsule conveying device, by two rows of capsule receivers being formed. A corresponding doubling of the output of the device is associated therewith.

In principle, there is a need to maximise the output of the devices of the capsules produced. To this end, on the one hand, the cycle number may be increased. However, the maximum cycle number nowadays is predominantly ca. 150 cycles per minute, close to what is physically possible, as the processing stations require a minimum time for supplying, metering and primarily for closing the capsules, which is not able to be reduced in practice. For example, when closing the capsules, this is caused by the air displacement during the course of the closing process.

A further possibility for increasing the output is by further increasing the number of capsule receivers per capsule conveying device. This approach has been implemented by the provision of a second row of capsule receivers. However, this possibility is also close to its physical limits. The more capsules provided for each capsule conveying device, the more capsules have to be filled simultaneously in the metering stations. The usual metering stations are either packing plunger stations or metering piston stations. In such metering stations, impact forces or, respectively, pressing forces have to be absorbed, said forces increasing with the number of capsule receivers. Even with a particularly suitable construction of the device, in particular specifically adapted statics, the increase in the total pressing force has an effect on the mobile metered mass. Although this may result in more pressing force being able to be absorbed, the cycle time has to be further reduced due to the mass inertia. There is a conflict of interests here, therefore.

Proceeding from the prior art set forth above, the object of the invention is to provide a device of the type mentioned in the introduction by which the output of the device may be increased relative to the prior art, using the smallest possible constructional space.

### BRIEF SUMMARY OF THE INVENTION

For a device of the type mentioned in the introduction, the invention solves the object by at least two belt portions arranged in succession being formed along the conveyor belt, a first group of processing stations arranged in succession being provided along a first belt portion, and at least one further group of processing stations arranged in succession being provided along at least one further belt portion, the groups of stations comprising at least one respective supply station for supplying capsules to be filled into the capsule receivers of the capsule conveying devices, at least one respective opening station for opening the capsules to be filled, by separating the capsule upper parts from the capsule lower parts, at least one respective metering station for filling the capsule lower parts with the material to be filled, at least one respective closing station for closing the filled capsules by placing the capsule upper parts onto the filled capsule lower parts and at least one ejection station for ejecting the filled capsules.

As known per se, the capsules of the device are supplied preclosed and empty. They are opened, filled and subsequently closed in the device. The capsule upper parts and capsule lower parts in each case may have a latching mechanism or the like in order to be releasably connected together and thereby closed. In the preclosed state supplied to the device, the latching mechanism has generally not yet been implemented so that the capsules may be easily opened in the device. After filling and closing the capsules, in particular by latching the capsule upper parts and capsule lower parts, the filled capsules are ejected. The function of the individual processing stations per se may, in principle, be implemented as is known from the prior art. Thus, for example, the opening stations may separate the capsule upper parts and capsule lower parts by means of a negative pressure device. The capsule conveying devices may have an upper part and a lower part in which in each case capsule receivers are provided for the capsule upper parts or, respectively, the capsule lower parts. The metering stations may, for example, comprise so-called packing plunger stations or so-called pipette stations. In packing plunger stations, for example, a pressed article with a predetermined dimensional stability is generally produced by successive compression of a powder to be filled by means of packing plungers, which is then transferred in a transfer region to the capsule lower parts. In particular, pellets may be filled into the capsule lower parts in the metering stations, even without a packing plunger or the like. The closing stations may latch together the capsule halves in a manner known per se. The ejection stations may, for example, comprise mechanical ejectors known per se.

In contrast to the prior art, according to the invention at least two belt portions arranged in succession are formed along the conveyor belt. A first belt portion is formed by a first groups of stations of processing stations arranged in succession and at least one further belt portion is formed by at least one further groups of stations of processing stations arranged in succession. The groups of stations comprise in each case the processing stations which are required for receiving, opening, filling, closing and ejecting the capsules. According to the invention, therefore, at least two complete production paths are formed in each case along the conveyor belt. The device according to the invention may thus be referred to as a “multiple rotary table capsule machine” in particular a “dual rotary table capsule machine”. The capsule conveying devices may convey the capsules received thereby, in particular in a cyclical manner, along the conveyor belt through the processing stations. In principle, however, a continuous conveyance is conceivable. The capsule conveying devices may be arranged, for example, on a conveyor wheel which rotates, in particular in a cyclical manner, so that the capsule conveying devices pass in succession through the processing stations along the conveyor belt in a stepwise manner. In particular, exactly the same number of capsule conveying devices may be provided as the total number of processing stations provided along the conveyor belt. In this case, due to the multiplication, in particular doubling, according to the invention of the normal production sequence, with a full volume along the conveyor belt a plurality of batches, in particular two batches, of capsules are in each case filled and ejected by the capsule conveying devices.

The invention is based on the recognition that by a suitable reduction of the total number of processing stations the arrangement of at least two full production paths along the conveyor belt and a multiplication of the output of the device associated therewith, relative to conventional devices, is possible without the constructional space of the device being increased in an undesirable manner. By reducing the number of processing stations to that generally needed, less space is required along the conveyor belt. This space which has been obtained is used for multiplying the production paths according to the invention. According to the invention, therefore, a considerable increase in the output is achieved without the cycle number per time unit or the number of capsule receivers of the capsule conveying devices having to be increased. By a suitable choice of process stations and optionally combining the processing stations actually required, it may be ensured that in spite of multiplying the production sequences along the conveyor belt, the overall number of processing stations is not multiplied in the same manner. For example, only one supply station may be provided for each group of stations. In principle, generally only one opening station and one closing station may be provided for each group of stations.

The invention also provides considerable advantages relative to a simple duplication of the entire device. Thus, for example, the cleaning time of a slightly larger machine relative to known devices is also considerably less than the cleaning time of a plurality of separate devices, as in particular the surface to be cleaned is not multiplied. The same applies to the production costs which are also not multiplied, as many components do not have to be multiplied with the multiplication of the production sequence, for example the cladding, machine frame, gear mechanism and drives, etc. The same applies to any peripheral devices which, in spite of the multiplication of the production sequence, only have to be provided once. Further advantages lie in the reduction of the required production spaces and the required operating personnel relative to production using a plurality of separate devices.

In particular, just two belt portions may be provided with in each case just one group of stations. The belt portions may then cover in each case substantially 180° of the conveyor belt, in the case of a circular conveyor belt. Such a symmetrical design of the belt portions, optionally with an identical design and arrangement of the processing stations, simplifies the sequences in the device according to the invention. However, other embodiments are also possible in which the belt portions are of different sizes, in particular when the groups of stations have a different number of processing stations and/or differently arranged and designed processing stations.

In principle, more than two belt portions may be formed along the conveyor belt, said belt portions then in each case comprising the above-mentioned processing stations. Thus, in addition to a first and second group of stations, optionally a third group of stations, a fourth group of stations, etc. exist, which in each case are arranged along a third belt portion, a fourth belt portion, etc. This applies, in particular, when a larger constructional space is available.

In this manner, not only a duplication but a triplication, quadruplication etc. of the conventional production sequence and correspondingly a triplication or, respectively, quadruplication etc. of the output may be achieved.

According to one embodiment for minimising the required number of stations, it may be provided that the supply station and the opening station of the first group of stations are integrated in a common supply and opening station of the first group of stations and/or that the supply station and the opening station of the at least one further group of stations are integrated in a common supply and opening station of the at least one further group of stations.

According to a further embodiment and also within the context of reducing the constructional space with maximum output, it may be provided that the first group of stations comprises no more than two metering stations and/or that the at least one further group of stations comprises no more than two metering stations. In the metering stations of the groups of stations, in a manner known per se, for example different, generally powdered or pellet-shaped, material may be filled into the capsule lower parts. In this case, for example, it may be a pharmaceutical material or a further material. In devices of the prior art, space is frequently provided for up to five different metering stations. In fact, the overwhelming number of commonly produced capsules have no more than two different ingredients. With this in mind, the restriction associated with this embodiment is acceptable in the sense of reducing constructional space.

The capsule conveying devices may in each case have a first and a second row of capsule receivers in order to maximise in this manner the output of the device. Provided the capsule conveying devices in each case have an upper part and a lower part, both the upper part and the lower part accordingly have two rows of capsule receivers. It is thus also possible that the groups of stations in each case comprise a first and a second supply station, the first supply station being configured to supply capsules respectively to the one row of capsule receivers of a capsule conveying device, and the second supply station being configured to supply capsules respectively to the other row of capsule receivers of the capsule conveying device. According to a further embodiment relevant thereto, it may be provided that the groups of stations in each case only comprise one supply station, the supply stations being configured in each case to supply capsules to both rows of capsule receivers of a capsule conveying device. As a result, a further reduction in the number of stations for each group of stations is possible.

According to a further embodiment, in each case at least one processing station of the groups of stations may be configured as a metering and ejection station, capsules not opened by the at least one opening station being ejected in the metering and ejection station. In this case, an ejection station arranged, for example, parallel to the metering station is assigned to the metering station, so that a metering and ejection station is produced. By means of this integration, a further reduction of the required constructional space is possible. The ejection may be carried out, for example, by a suitable ejector. Unopened capsules may then be supplied to a collection device for defective capsules.

A collection device common to all groups of stations may also be provided, said collection device being arranged such that the capsules ejected in the ejection stations of all groups of stations are supplied thereto. A testing device common to all groups of stations may also be provided for testing the capsules filled in the processing stations of all groups of stations. The common testing device may be arranged such that the capsules ejected into the ejection stations of all groups of stations are supplied thereto for testing. By this use of the testing station which is generally configured as an external device for a plurality of groups of stations, a further simplification of the production sequence is possible using a small amount of constructional space. In particular, the validation or, respectively, testing of a batch of capsules for correct production is thus only required in one common testing device.

According to a further embodiment, it may be provided that the groups of stations in each case comprise two ejection stations, in each case one of the ejection stations being configured to supply satisfactory capsules to a first collection device and respectively the other of the ejection stations being configured to supply defective capsules to a second collection device and the groups of stations in each case comprising a testing device arranged upstream of the ejection stations in the conveying direction of the capsules along the conveyor belt, for testing and for assigning the capsules to one of the two respective ejection stations. The testing of the capsules takes place in this case before the ejection of the capsules. This may be advantageous as the capsules then still have a fixedly defined position in the capsule receivers.

When testing and sorting after ejection, the capsules optionally have to be initially separated again which involves further cost.

According to a further embodiment relevant thereto, it may be provided that the satisfactory capsules ejected in the first ejection stations of the groups of stations are supplied to a first collection device common to all groups of stations, and in that the defective capsules ejected in the second ejection stations of the groups of stations are supplied to a second collection device common to all groups of stations. By means of this embodiment, by providing a plurality of testing devices for the groups of stations, however, a simplification of the construction is achieved.

According to a further embodiment, it may be provided that the groups of stations in each case comprise only one ejection station, the ejection stations comprising in each case a device for differentiating between satisfactory capsules and defective capsules. Thus only two ejection stations have to be provided in, for example, two groups of stations. The satisfactory capsules or, respectively, defective capsules identified in the ejection stations of the groups of stations, may be then supplied to a collection device for satisfactory capsules or, respectively, a collection device for defective capsules. In each case a common collection device for satisfactory capsules and a common collection device for defective capsules may be assigned to all groups of stations. It is, however, also possible that one respective collection device for satisfactory capsules and one respective collection device for defective capsules is assigned to the groups of stations.

According to a further embodiment, at least one of the ejection stations may comprise a cleaning device which is configured to clean the capsule receivers of the capsule conveying devices. Such cleaning devices may, for example, comprise suction devices for material from the metering stations which potentially collects in the region of the capsule receivers. By integrating the cleaning function in the ejection station, a further reduction of the number of stations is achieved. For example, with two ejection stations provided for each group of stations, in particular the last of the ejection stations may be provided with the cleaning device.

### BRIEF DESCRIPTION OF THE DRAWINGS

Exemplary embodiments of the invention are described hereinafter with reference to the figures, in which schematically:

FIG. 1 shows a device according to the invention in a schematic plan view according to a first exemplary embodiment, and

FIG. 2 shows a device according to the invention in a schematic plan view according to a second exemplary embodiment.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

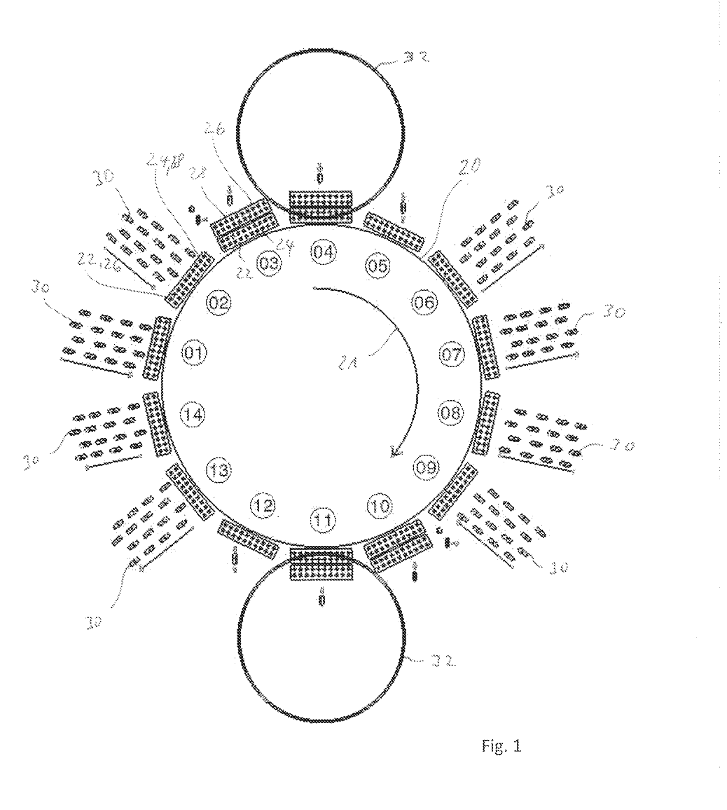

Provided nothing further is specified, the same reference numerals denote the same objects in the figures. The device according to the invention shown in FIG. 1, for filling and closing capsules made up of a capsule upper part and a capsule lower part, has a plurality of processing stations arranged along a conveyor belt 20, which is circular in the example shown. In the example shown, the device has a total of 14 processing stations which are shown by encircled numbers in FIG. 1 for illustrative purposes. In the example shown in FIG. 1 two belt portions are formed, arranged in succession along the conveyor belt 20, said belt portions in each case covering 180° of the conveyor belt 20. The processing stations denoted in FIG. 1 by the numbers 01 to 07 are arranged along a first belt portion. In FIG. 1 the processing stations denoted by the numbers 08 to 14 are arranged along the second belt portion.

In FIG. 1 upper and lower parts, known per se, of a total of fourteen capsule conveying devices are shown by the reference numerals 22, 26. The upper and lower parts 22, 26 have in each case two rows of capsule receivers 24, 28. On the processing stations with the numbers 03, 04 and 10, 11 in FIG. 1 the upper parts 22 of the capsule conveying devices are shown separated from the lower parts 26. In the present case, each of the rows has ten capsule receivers 24, 28 so that each of the capsule conveying devices is able to receive a total of twenty capsules. The capsule conveying devices in the present case are arranged on a conveyor wheel which supplies the capsule conveying devices in the example shown in a cyclical manner to the processing stations shown by the numbers 01 to 14, as illustrated in FIG. 1 by the arrow 21. The processing stations shown in FIG. 1 by the numbers 01 to 07 form a first group of stations of the device and the processing stations shown by the numbers 08 to 14 form a second group of stations of the device. In this case, the respective following pairs of processing stations are configured identically:
01-08, 02-09, 03-10, 04-11, 05-12, 06-13, 07-14

The processing stations shown by the numbers 01 and 08 are in each case supply stations in which capsules 30 in the unfilled and preclosed state are supplied to the capsule conveying devices and are inserted into the capsule receivers 24, 28 of the upper parts 22 and lower parts 26 of the capsule conveying device. In this case, the supply stations shown by the numbers 01 and 08 load a first of the two rows of capsule receivers 24, 28. The processing stations shown by the numbers 02 and 09 are also supply stations in which capsules 30 are in turn supplied in the preclosed and unfilled state to the respective other row of capsule receivers 24, 28 of the capsule conveying devices. The processing stations shown by the numbers 03 and 10 are in each case spacers for further processing stations to be optionally provided, for example metering stations. By opening stations being integrated, for example, in the supply stations 02 and 09, the capsules 30 retained in the capsule receivers 24 28 are separated into capsule upper parts and capsule lower parts. This may take place, for example, by applying a suitable negative pressure. The upper parts 22 of the capsule conveying devices shown in the stations 04 and 11 retain the capsule upper parts and convey said parts further whilst the lower parts 26 of the capsule conveying devices retain the capsule lower parts and convey said parts further.

In FIG. 1 metering stations in which a powdery or pellet-shaped material, for example, is supplied to the capsule lower parts are shown by the numbers 04 and 11. Corresponding filling devices are illustrated by the reference numeral 32 in FIG. 1. Said filling devices may comprise, for example, a plurality of packing plungers arranged along a circular path in a manner known per se. Provided the stations with the numbers 03 and 10 in FIG. 1 also comprise metering stations, therefore, two different materials, for example, may be filled into the capsule lower parts. As is visible with reference to the processing stations shown by the numbers 03 and 04 or, respectively, 10 and 11, the respective radial inner upper parts 22 of the capsule conveying devices and the radial outer lower parts 26 of the capsule conveying devices move together in these stations along the conveyor belt 20. For example, the processing stations 04 and 11 of the device of FIG. 1 may be configured to eject the capsules 30 not opened by the opening station.

In each case a closing station is shown by the numbers 05 and 12 in FIG. 1, in which the filled capsules 30 are closed by the previously released capsule upper parts again being placed onto the capsule lower parts. The capsule upper parts may, for example, be latched onto the capsule lower parts. For the closing function, the upper parts 22 of the capsule conveying devices and the lower parts 26 of the capsule conveying devices may be moved toward one another.

The processing stations with the numbers 06 or, respectively, 13 in FIG. 1, toward which the capsule conveying devices subsequently move, are in each case ejection stations in which such capsules 30 which do not satisfy specific quality criteria are ejected (“defective capsules”). To this end, specific testing devices may be provided. The defective capsules may be supplied to a collection container for rejected capsules, not shown. The processing stations with the numbers 07 and 14 in FIG. 1, toward which the capsule conveying devices subsequently move, are also ejection stations, in this case for satisfactory capsules i.e. capsules which satisfy the predetermined quality criteria. The satisfactory capsules may accordingly be supplied to a collection device for satisfactory capsules. Naturally, the ejection of the defective capsules and satisfactory capsules could also be reversed i.e. initially the satisfactory capsules and subsequently the defective capsules. Moreover, a cleaning device may be assigned to the processing stations shown by the numbers 07 and 14, in which the capsule conveying devices are cleaned of contaminants which may be present, for example powdered or pellet-shaped material.

It may be seen that the device according to the invention shown in FIG. 1 is implemented by a total of only fourteen processing stations on two complete production paths for filling the capsules 30. Accordingly, via the processing stations 07 and 14 in FIG. 1, twice as many capsules 30 are output as in a conventional device of this type. By reducing the number of metering stations to the number actually required in most cases and the suitable combination of processing stations, it is possible to double the output without the number of processing stations being doubled and thus the constructional space being undesirably greatly increased.

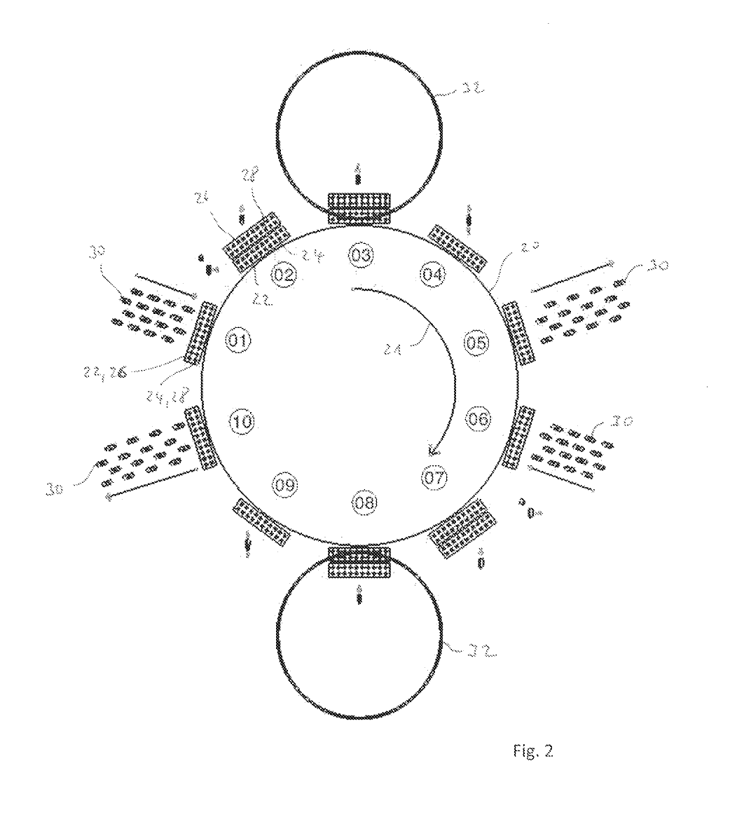

The device according to the invention shown in FIG. 2 corresponds substantially to the device of FIG. 1. In contrast to the device of FIG. 1 the device of FIG. 2 only requires a total of ten processing stations. Once again, the conveyor belt 20, which is circular in the example shown, is subdivided into two belt portions, the processing stations shown by the numbers 01 and 05 in FIG. 2 forming a first group of stations along the first belt portion and the processing stations shown by the numbers 06 and 10 in FIG. 2 forming a second group of stations along the second belt portion.

The reduction of the processing stations relative to FIG. 1 is firstly achieved by the supply stations, shown by the numbers 01 and 06 in FIG. 2, being configured to supply capsules 30 to both rows of capsule receivers 24 of the lower parts 26 of the capsule conveying devices. The processing stations shown in FIG. 2 by the numbers 02 and 03 or, respectively, 07 and 08 correspond to the processing stations shown in FIG. 1 by the numbers 03 and 04 or, respectively, 10 and 11. The closing stations shown in FIG. 2 by the numbers 04 and 09 correspond in turn to the closing stations shown in FIG. 1 by the numbers 05 and 12. A further saving of processing stations relative to the exemplary embodiment of FIG. 1 is achieved in the exemplary embodiment of FIG. 2 by only one ejection station being provided per group of stations, namely the ejection stations shown by the numbers 05 and 10. In the exemplary embodiment of FIG. 2, the classification of the produced capsules 30 into satisfactory capsules and defective capsules takes place downstream or upstream of the ejection stations 05 and 10, for example already in the region of the metering or closing stations. To this end, a suitable testing device is provided which monitors the capsules 30 ejected by the ejection stations 05 and 10 for correct production. Depending on this, the capsules 30 may be sorted by sorting devices known per se into satisfactory capsules and defective capsules and supplied to corresponding collection devices.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

What is claimed is:

1. A device for filling and closing capsules (30) made up of a capsule upper part and a capsule lower part, comprising a plurality of processing stations arranged along a preferably circular conveyor belt (20) and a plurality of capsule conveying devices which in each case have a plurality of capsule receivers (24) for receiving one respective capsule, the capsule conveying devices conveying received capsules (30) along the conveyor belt (20) through the processing stations,
characterised in that at least two belt portions arranged in succession are formed along the conveyor belt (20), a first group of processing stations arranged in succession being provided along a first belt portion, and at least one further group of processing stations arranged in succession being provided along at least one further belt portion, the groups of stations comprising at least one respective supply station, for supplying capsules (30) to be filled into the capsule receivers (24) of the capsule conveying devices, at least one respective opening station for opening the capsules (30) to be filled, by separating the capsule upper parts from the capsule lower parts, at least one respective metering station for filling the capsule lower parts with the material to be filled, at least one respective closing station for closing the filled capsules (30) by placing the capsule upper parts onto the filled capsule lower parts and at least one ejection station for ejecting the filled capsules (30).

2. The device according to claim 1, characterised in that the supply station and the opening station of the first group of stations are integrated in a common supply and opening station of the first group of stations and/or that the supply station and the opening station of the at least one further group of stations are integrated in a common supply and opening station of the at least one further group of stations.

3. The device according to claim 1, characterised in that the first group of stations comprises no more than two metering stations and/or that the at least one further group of stations comprises no more than two metering stations.

4. The device according to claim 1, characterised in that the capsule conveying devices of the groups of stations in each case have a first and a second row of capsule receivers (24).

5. The device according to claim 4, characterised in that the groups of stations in each case comprise a first and a second supply station, the first supply station being configured to supply capsules (30) respectively to the one row of capsule receivers (24) of a capsule conveying device, and the second supply station being configured to supply capsules (30) respectively to the other row of capsule receivers (24) of the capsule conveying device.

6. The device according to claim 4, characterised in that the groups of stations in each case comprise only one supply station, the supply stations being configured in each case to supply capsules (30) to both rows of capsule receivers (24) of a capsule conveying device.

7. The device according to claim 1, characterised in that in each case at least one processing station of the groups of stations is configured as a metering and ejection station, capsules (30) not opened by the at least one opening station being ejected in the metering and ejection station.

8. The device according to claim 1, characterised in that a collection device common to all groups of stations is further provided, said collection device being arranged such that the capsules (30) ejected in the ejection stations of all groups of stations are supplied thereto.

9. The device according to claim 1, characterised in that a testing device common to all groups of stations is further provided for testing the capsules (30) filled in the processing stations of all groups of stations.

10. The device according to claim 1, characterised in that the groups of stations in each case comprise two ejection stations, in each case one of the ejection stations being configured to supply satisfactory capsules to a first collection device and respectively the other of the ejection stations being configured to supply defective capsules to a second collection device and in that the groups of stations in each case comprise a testing device arranged upstream of the ejection station in the conveying direction of the capsules (30) along the conveyor belt (20), for testing and for assigning the capsules (30) to one of the two respective ejection stations.

11. The device according to claim 10, characterised in that the satisfactory capsules ejected in the first ejection stations of the groups of stations are supplied to a first collection device common to all groups of stations, and in that the defective capsules ejected in the second ejection stations of the groups of stations are supplied to a second collection device common to all groups of stations.

12. The device according to claim 1, characterised in that the groups of stations in each case comprise only one ejection station, the ejection stations comprising in each case a device for differentiating between satisfactory capsules and defective capsules.

13. The device according to claim 1, characterised in that at least one of the ejection stations further comprises a cleaning device which is configured to clean the capsule receivers (24) of the capsule conveying devices.
